(19) United States
(12) Patent Application Publication
(10) Pub. No.: US 2026/0016325 A1
(43) Pub. Date: Jan. 15, 2026

(54) STATE DETECTION OF AN ADHESIVE CONNECTION

(71) Applicant: Gottlieb Binder GmbH & Co. KG, Holzgerlingen (DE)

(72) Inventors: Lars Heepe, Tübingen (DE); Dirk-Michael Drotlef, Tiefenbronn (DE)

(73) Assignee: Gottlieb Binder GmbH & Co. KG, Holzgerlingen (DE)

(21) Appl. No.: 19/265,330

(22) Filed: Jul. 10, 2025

(30) Foreign Application Priority Data
Jul. 12, 2024 (DE) 102024119934.2

(51) Int. Cl. G01D 21/00

(52) U.S. Cl. CPC G01D 21/00

(57) ABSTRACT

A method for the state detection of a connection system includes a first adhesive means, a second adhesive means and a sensor arrangement. The method determines a position of the adhesive means relative to each other, wherein the first adhesive means is brought close to and/or attached to the second adhesive means and at least one parameter relating to the positioning is detected by the sensor arrangement. After alignment of the adhesive means, a final attachment can be carried out. The method can equally be used to detect the adhesion of the first adhesive means to the second adhesive means and/or to determine the loading or non-loading of an adhesive connection. Processed and/or unprocessed sensor data can be sent wirelessly by means of a communication component. A connection system is designed to carry out the aforementioned method and to a set including the connection system and a mobile router.

### CROSS-REFERENCE TO RELATED APPLICATIONS

This application claims priority to German Patent Application No. DE 10 2024 119 934.2 filed Jul. 12, 2024, the entire contents of which are hereby incorporated in full by this reference.

### FIELD OF THE INVENTION

The invention relates to a method for the state detection of a connection system. The invention further relates to a connection system which is designed to carry out the aforementioned method and to a set comprising the connection system and a functional element, in particular, a mobile router. The invention further relates to a method for producing the aforementioned connection system and a further development of the aforementioned connection system in which the connection system has a communication component.

### BACKGROUND OF THE INVENTION

It is known to combine connection systems, in particular, manually detachable connection systems, with sensors and devices for further processing and/or transmission of sensor data.

CN 114 608 623 A describes a flexible two-dimensional sensor arrangement using a hook and loop fastener in which an electrically conductive structure is arranged on the back of each adhesive element, while a sensor is attached to the back of the respectively opposite adhesive element. The sensor is connected to the electrically conductive structure via a local feedthrough of conductor elements from the back to the adhesive side of the hook and loop fastener. When the adhesive connection is made, the conductor elements can come into contact with each other.

DE 10 2018 104 774 B3 describes an electrode that can be worn on the skin and used as a sensor. The skin contact layer of the electrode is arranged on one part of a hook and loop fastener and can be flexibly positioned on a carrier field forming the second part of the hook and loop fastener. The passage of an electrical potential through the hook and loop fastener connection is ensured by the electrical conductivity of the hook and loop fastener parts, preferably by means of a silver coating.

U.S. Pat. No. 5,714,706 A discloses a shoe insole that can be used as an input field for controlling sounds. A piezoelectric sensor is arranged on a substrate plate with the aid of a hook and loop fastener.

DE 10 2010 060 222 B4 describes a textile product having an electrical or electronic component, for example a sensor. The textile product is assigned contact means having a hook and loop fastener. The closure parts of the hook and loop fastener each have electrically conductive contact elements through which an electrically conductive connection can be established across the hook and loop fastener.

CN 105 640 542 B, CN 218 501 232 U and CN 109 350 015 A each describe the arrangement of sensors for medical applications. Hook and loop fasteners are used to connect the sensors to a carrier material or to attach a sensor carrier to a patient.

US 2020/0338750 A1 describes a micro-structured adhesive means, wherein an electrode and/or a piezoelectric element can be considered as components of the adhesive means. The piezoelectric element can function, among other things, as a force and touch sensor.

WO 03/085273 A1 describes a hook and loop fastener that can be released by electrical stimulation. Parts of the hooks of a closure part consist of electrically responsive shape-memory material, wherein the respective hooks have a further electrically “inert” material. If an electric current is passed through the hooks, they are straightened thereby and the hook and loop fastener connection is released. The hook and loop fastener, or at least parts of it, must have an appropriate electrical conductivity.

DE 20 2021 002 148 U1 describes a textile lifting device which has an information device, wherein the information device can be reversibly fastened to the lifting device on one side. This can be done, for example, by using a hook and loop fastener. In one embodiment, the information device has one or more RFID (radio-frequency identification) transponders.

CN 212 433 805 U and CN 209 560 579 U each describe the fastening of an RFID transponder by using a hook and loop fastener.

US 2012/0123291 A1 describes a measuring apparatus for determining bio-impedance. For this purpose, a plurality of probes is arranged on a flexible belt. In addition, the belt contains a device for wireless transmission of impedance data. In some versions the belt is attached to the body with the aid of a hook and loop fastener.

U.S. Pat. No. 10,265,019 B2 similarly describes a sensor arrangement, sensors for monitoring physiological parameters being arranged on a flexible headband (or similar headwear) which can be affixed to the body, for example, by using a hook and loop fastener. The sensor data transmission can in turn take place via a wireless data transmission module arranged on the headband.

U.S. Pat. No. 11,039,530 B2 describes a communication device arranged on a structure and which can be attached to a garment to create a “connected garment system.” The communication device can include, among other things, an NFC (near-field communication) sensor and can be attached to the item of clothing with the aid of a hook and loop fastener. The controller of the communication device can be housed in a housing that can be closed with a hook and loop fastener.

### SUMMARY OF THE INVENTION

In the prior art, the sensors measure parameters that do not themselves characterize a connection system.

### Object of the Invention

In contrast, it is the object of the invention to make it possible to determine a state of a connection system, in particular, of a connection system for producing detachable connections.

### Description of the Invention

This object is achieved according to the invention by a method for state detection according to claim 1, a connection system according to claim 8, a set according to claim 15 and a method for producing a connection system according to claim 16. The dependent claims reflect preferred embodiments.

The method comprises approaching and/or attaching a first adhesive means to a second adhesive means and detecting by a sensor arrangement at least one parameter relating to a state of an adhesive connection formed or to be formed between the first and the second adhesive means. The second adhesive means may be in the form of a surface. If the first adhesive means is initially only brought close to the second adhesive means, the final attachment takes place after the detection of the at least one parameter, at least one further parameter being subsequently detectable during a further run of the method.

A state of the adhesive connection can be understood to mean an existing or non-existing adhesive connection. For this purpose, the parameter can provide information as to whether or not the adhesive means involve an adhesive connection. For example, it can be provided that there is a pre-determined minimum distance between the adhesive means. Furthermore, for example, it can be provided that for the presence of an adhesive connection a pressure sensor determines a minimum pressing pressure. This can ensure a controlled bringing together or attaching of the adhesive means to each other.

Alternatively or additionally, the parameter can provide information about whether an adhesive connection by the adhesive means is about to occur, in other words, whether the adhesive means for forming a pre-determined adhesive connection to each other are properly positioned and/or aligned.

The state of the adhesive connection can alternatively or additionally be understood to include a strength of the discussed adhesive connection. In this way a sufficient strength of the adhesive connection can be affected and/or a reduction of the strength of the adhesive connection can be detected early. For example, the value of the parameter can be compared to known reference values, the effect of which the strength of the adhesive connection is known. For example, a pressing pressure between the adhesive means can be used to assess the strength of the adhesive connection.

In particular, the first adhesive means can be brought close to or attached to the second adhesive means depending on, in particular, using, the at least one detected parameter relating to the state of the adhesive connection.

The method can provide for an evaluation of the at least one detected parameter. In particular, the parameter is compared with stored reference variables and/or reference tables and/or reference variables are calculated as a function of the parameter, whereby the reference variables enable the parameter value to be assigned, preferably unambiguously, to known states of the adhesive connection. This allows the state of the adhesive connection to be determined particularly reliably as a function of the parameter.

Particularly preferably, the at least one parameter is used to determine the state of the adhesive connection directly between the adhesive means. In other words, a connection of the adhesive means is determined on the basis of internal and/or external influences on the adhesive connection. In this way, a statement can be made about the load and/or the load-bearing capacity of the adhesive closure or the adhesive connection, irrespective of the use of the adhesive closure. For example, an external tensile load on the adhesive connection and a surface-specific holding force of the adhesive means can be used to output a statement about the permissible load on the adhesive closure or the adhesive connection.

In particular, the evaluation can involve determining a physical variable from the at least one parameter. In other words, the detected parameter can be used to infer state variables of the adhesive connection. In particular, an adhesive contact and/or a contact pressure of the adhesive means can be determined from a relative position of the adhesive to one another. For example, if the adhesive means are attached to each other, a relative small distance between the adhesives can indicate a strong adhesive connection. A relative medium distance can indicate a reduced adhesive connection and a large distance can indicate a load limit of the adhesive connection. Typically, relative positions of the adhesive means are determined by determining the position between defined reference positions on the adhesive means. This allows deformations, in particular, swelling and/or compression, of the adhesive means to be taken into account.

Preferably, the method can provide an output of the at least one parameter, the value of the parameter, further determined physical variables and/or the state of the adhesive connection. The output can be visual. The output can be sent to an electronic monitoring system for further processing. This allows the adhesive connection to be monitored particularly reliably.

The method is typically carried out in a computer-assisted manner. In other words, the method is executed using at least one computer. Particularly preferably, the method is carried out automatically.

The method steps of the method can be repeated, in particular, multiple times. In particular, the adhesive means can be released from each other if the adhesive connection is not formed as expected. In this way, bringing the adhesive means close together or attaching them to each other can be carried out iteratively and an adhesive connection to be formed can be ensured.

Preferably, one of the following physical variables between the first and the second adhesive means is detected by means of a sensor element of the sensor arrangement: displacement, strain, force, pressure, radiation energy, a molar concentration, or a magnetic field strength.

The sensor arrangement typically comprises at least one technical sensor for recording the parameter related to the state of the adhesive connection.

In a particularly preferred variant of the method, the sensor element is an optical sensor element, a magnetic sensor, a pressure sensor, a force sensor or a strain sensor.

Sensor elements from the group of optical sensor elements can, for example, be sensors that detect the radiant energy of the ambient lighting or sensors that utilize the detection of the reflection of a previously emitted light beam. From the group of magnetic sensors, Hall sensors and reed switches are particularly suitable. Bidirectional differential elements are preferred as pressure sensors. Examples of force sensors and strain sensors include mechanical, capacitive, inductive and piezoelectric sensor elements. In principle, any sensor elements suitable for detecting at least one parameter can be used. The examples given of how the sensor elements work are not to be understood as an exhaustive listing. In particular, it is conceivable that sensor elements can be assigned to a plurality of categories (such as fiber-optic strain sensors).

The at least one parameter can provide information about the absolute position of the first adhesive means. Alternatively or additionally, the at least one parameter allows a statement to be made about the position of the first adhesive means in relation to the second adhesive means. In this respect, it may be advantageous to initially only bring the adhesive means closer together and in a later method step to join them together. It is also conceivable that the first adhesive means for determining the positioning is attached and, if necessary, detached several times in an iterative process in which the method is repeated several times until it is finally attached in the desired position.

The at least one parameter may further represent the state of adhesion of the first adhesive means to the second adhesive means, at least in a region of a connection system. In this case, the adhesive connection can be produced in the first method step.

Alternatively or additionally, the at least one parameter can provide information about the load on the adhesive connection. For example, a preload to be applied when making the connection can be detected and checked. Furthermore, a check can be made as to whether the load on the adhesive connection is still within an expected range even after a certain period of time. The detection of the load on the adhesive connection includes the detection of a non-loading. The non-loading can occur especially when the system is open, i.e., the adhesive connection is not established. In the present context, this is also understood as a statement about the load on the adhesive connection.

When carrying out the method according to the invention, a plurality of parameters relating to different properties of the state of the connection system and/or different local regions of the connection system can be recorded as optional alternatives.

Further preferably, the sensor arrangement comprises a plurality of identical or different sensor elements for detecting the at least one parameter.

By the arrangement of a plurality of sensor elements, a sensor matrix can be formed, which can be used to easily determine the position. Furthermore, information can be obtained by comparing data from different—preferably similar—sensor elements.

In one embodiment of the method, the data or a portion of the data of the sensor arrangement are/is preferably stored at least temporarily in a storage device of the connection system. Using a storage device eliminates the need to handle the data in real time (for example, during data transmission or data processing).

In a further embodiment, a data processing device of the connection system is used to process the data from the sensor device. Preferably, data from different sensor elements can be combined and/or compared to each other in order to derive the at least one parameter.

A particularly preferred development of the method according to the invention provides for wireless transmission of the data acquired by the sensor arrangement by means of a communication component of the connection system. The data can be processed before sending and/or sent as raw data.

A passive element that does not have its own power supply is particularly suitable as a communication component. In this case, wireless transmission can be carried out, in particular, by means of a reader device which provides the necessary energy supply by generating a magnetic or electromagnetic field.

The object is also achieved by a connection system comprising a first adhesive means, a second adhesive means, a sensor arrangement and a controller, the connection system being set up to carry out the method according to the invention. The sensor arrangement can, in particular, comprise one or more sensors which are arranged or formed in or on a sensor film (carrier film).

In order to ensure the possibility of carrying out the method in various developments, the connection system preferably has a storage device and/or a data processing device. In particular, it may be advantageous if the connection system has a plurality of storage devices and/or data processing devices.

Particularly preferably, the sensor arrangement is arranged or formed on or in the first and/or on or in the second adhesive means. In particular, embodiments are preferred in which one or more sensor elements are an integral part of the structure of the adhesive means or of one of the adhesive means.

The adhesive means are preferably two corresponding halves of an adhesive fastener in the form of a hook and loop fastener or clip fastener, one of the adhesive means preferably having hooks, mushroom heads or palm-shaped adhesive elements, while the other adhesive means preferably has a loop strip, a velour strip, a fabric, a nonwoven fabric and/or likewise hooks, mushroom heads or palm-shaped adhesive elements. The loop strip, velour strip, fabric or nonwoven fabric, in particular, have loops and/or fibers for forming an operative connection with corresponding adhesive elements.

It is equally conceivable for the two adhesive means to comprise two halves of a snap fastener that are suitable for interacting. Likewise, the adhesive means can each have a plurality of such halves.

In an alternative embodiment, one of the adhesive means has micro-structures to utilize intermolecular forces. The micro-structures are preferably projections protruding from a carrier material, the projections preferably having a height of 20 μm to 800 μm, particularly preferably 40 μm to 70 μm, most preferably 50 μm to 60 μm. The projections have as material, in particular, an elastomer. The areal density of the projections is preferably in the range of 10 000 projections per cm² up to 100 000 projections per cm², particularly preferably in the range of 15 000 projections per cm² up to 50 000 projections per cm². Furthermore, the projections have, in particular, a maximum width of 500 nm to 3 μm, particularly preferably of 30 to 100 μm. In this case, the corresponding adhesive means is a sufficiently smooth surface and can be, for example, a wall or a glass pane.

It is also conceivable for the connection system to be realized using an adhesive or an adhesive layer.

In order to ensure the possibility of carrying out the aforementioned, particularly preferred development of the method, the connection system preferably has a communication component.

Further preferably, the communication component is arranged or formed on or in one of the adhesive means. Analogously to the arrangement/design of the sensor arrangement, embodiments are also preferred in which the communication component is an integral part of the structure of one of the adhesive means or of both adhesive means. Furthermore, analogously to the arrangement/design of the sensor arrangement, the communication component can also be arranged or formed on or in a carrier film.

What is meant by the term “integral part of the structure” can be deduced from the manufacturing method claimed below. It is nevertheless understood that the feature also encompasses structures comprising one or more adhesive means and a sensor arrangement and/or a communication component which are created by other manufacturing methods, but in which manufacturing methods a structural composite of a comparable type is produced.

The communication component may be configured to include the storage device; further, it may be configured to alternatively or additionally include the data processing device.

As mentioned above, a passive element that does not require a connected power supply is particularly suitable as a communication component.

For example, a passive RFID (radio-frequency identification) transponder, in particular, an NFC (near-field communication) transponder or an HF (high-frequency) transponder or a UHF (ultra-high frequency) transponder, is used here. In this case, sending the data requires an external reader. The advantages are, in particular, the simple structure, the easy connectivity, the low energy consumption and the interoperability. Nevertheless, the method and connection system according to the invention can also be implemented using an active or semi-passive communication component. In addition to active and semi-passive RFID transponders, this includes, in particular, devices that use technologies such as Bluetooth, infrared transmission, wi-fi, mobile communications, ZigBee or LoRaWAN (long-range wide area network) for communication.

In one embodiment, the connection system has at least two, preferably more than two, communication components. For example, a plurality of RFID transponders equipped with sensor elements can be arranged in the form of a matrix on an adhesive means, wherein a signal from certain transponders can be used to determine the position. Alternatively, the sensor arrangement can be formed by the RFID transponders themselves. The RFID transponders do not have separate sensor elements but provide both the sensor arrangement and the communication components. For example, a reader device arranged on a corresponding adhesive means of the connection system can be used to make a statement about the position of the adhesive means relative to each other by determining which particular RFID transponder responds to a query from the reader device.

In a preferred application, the connection system is available as a set in combination with a functional element. The functional element can, in particular, be a mobile router, preferably a 5G router. The functional element can preferably be arranged on one of the adhesive means. If the functional element is a mobile radio router, it can either operate independently of the sensor arrangement and/or of the communication component of the connection system or be configured to read out or receive and forward the data of the sensor arrangement. Independently of this, the functional element can also be understood as any object to be adhered for which a state of the associated adhesive connection is to be determined. In particular, other network components (e.g., repeaters) or other electronic components (screens, LED films) can be considered as functional elements.

The object is also achieved by a method for producing a connection system, a sensor arrangement being integrated in a first and/or a second adhesive means or being arranged on a first and/or second adhesive means. The integration/arrangement is carried out by weaving or embedding, in particular, embedding in a cavity, or by surface bonding.

An alternative or further method step includes the integration/arrangement of a communication component in or on the first and/or second adhesive means by weaving, embedding, in particular, embedding in a cavity, surface bonding, printing or vapor deposition.

The two method steps do not necessarily have to be carried out one after the other. It is also conceivable that, for example, a sensor arrangement and a communication component are embedded in one and the same cavity at the same time. Furthermore, it is also possible to implement the manufacturing method using only one of the method steps, with the other method step being considered optional. The connection system can be designed as explained above and/or in the drawing description.

A particularly advantageous implementation of the manufacturing method can be achieved by using a continuous sensor film and/or a continuous film carrying communication components, the respective sensor or communication elements being arranged or formed, in particular, at regular intervals on or in the film. This means the connection system can be manufactured in a continuous process. For example, one of the adhesive means can be unwound from a roll (or fed directly from its own production process) and provided with an adhesive means in a continuous process, onto which the sensor film and/or the communication component-carrying film can then be attached in a further continuous process. The relevant film can also be unwound from a roll. Subsequently, a second adhesive layer, in particular, can be attached in order to achieve embedding of the relevant carrier film.

Similarly, continuous production can be achieved by arranging a sensor arrangement/communication component (possibly with a part of a carrier film) in sections on the back of one of the adhesive means and then coating it with an adhesive layer.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

In the drawings:

FIG. 1 shows a set comprising a functional element, here in the form of a mobile router, and a connection system, the connection system comprising a sensor arrangement—having optical sensor elements—and two communication components;

FIG. 2a is a partial section side view of another connection system in the connected state with a magnet and a sensor arrangement—comprising a magnetic sensor—as well as a communication component;

FIG. 2b is a partial section side view of the connection system of FIG. 2a in the detached state;

FIG. 3a is a partial section side view of another connection system in the connected state with a magnet and a sensor arrangement—comprising a magnetic sensor—as well as a communication component;

FIG. 3b is a partial section side view of the connection system of FIG. 3a in the detached state;

FIG. 4a shows a detail of another connection system in the detached state with a magnet and a sensor arrangement—comprising magnetic sensors—as well as a display;

FIG. 4b shows a detail of the connection system from FIG. 4a in the connected or proximal state in misalignment, as well as the corresponding display;

FIG. 4c shows a detail of the connection system from FIGS. 4a and 4b in the connected or proximal state in correct alignment, as well as the corresponding display;

FIG. 5a is a partial section side view of another connection system in the connected state and loaded in the connection direction with a sensor arrangement—comprising a pressure sensor—and an output value of the pressure sensor;

FIG. 5b is a partial section side view of the connection system of FIG. 5a in the connected state and loaded against the connection direction, as well as a corresponding sensor output value;

FIG. 5c is a partial section side view of the connection system from FIGS. 5a and 5b in the detached state and a corresponding sensor output value;

FIG. 5d shows a visualization of the output values from FIGS. 5a-5c;

FIG. 6a is a flowchart of a further development of a method according to the invention;

FIG. 6b is a flowchart of a further development of the method according to the invention;

FIG. 7 is a flowchart of a manufacturing method for a connection system;

FIG. 8 shows detail views of four variants of a first adhesive means with a sensor arrangement;

FIG. 9 shows a detail of another variant of a first adhesive means with a sensor arrangement.

### DETAILED DESCRIPTION OF THE INVENTION AND DRAWINGS

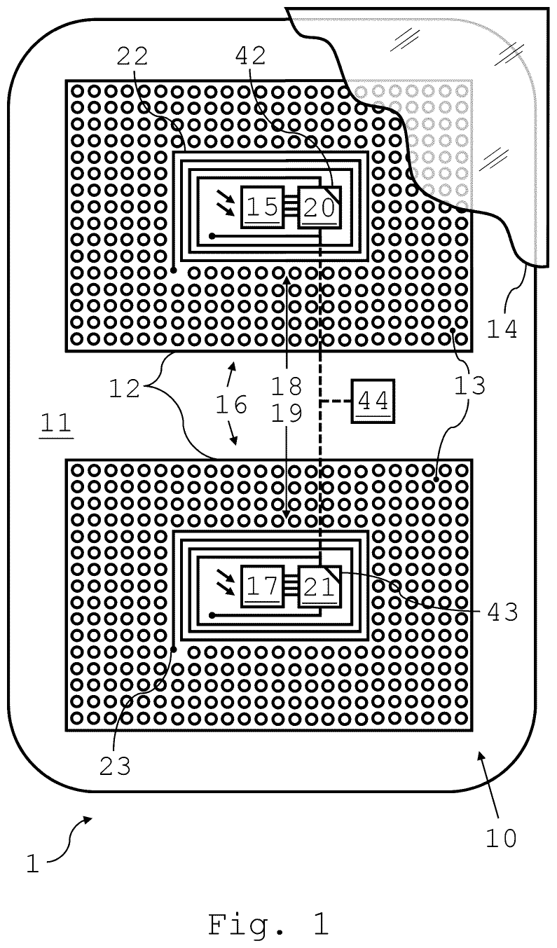

FIG. 1 shows a set 1 comprising a functional element, here in the form of a mobile router 11, and a connection system 10, the connecting system 10 having a first adhesive means 12, which, in the context of this presentation, is designed in two parts. The first adhesive means 12 is with the aid of a micro-structured surface 13 of the first adhesive means 12 arranged on a second adhesive means 14 (shown in detail).

In the present exemplary embodiment, the second adhesive means 14 is formed by a glass pane. Embedded in the first adhesive means 12 are a first optical sensor element 15 and a second optical sensor element 17, each of which detects a radiation energy. The two optical sensor elements 15, 17 form the sensor arrangement 16.

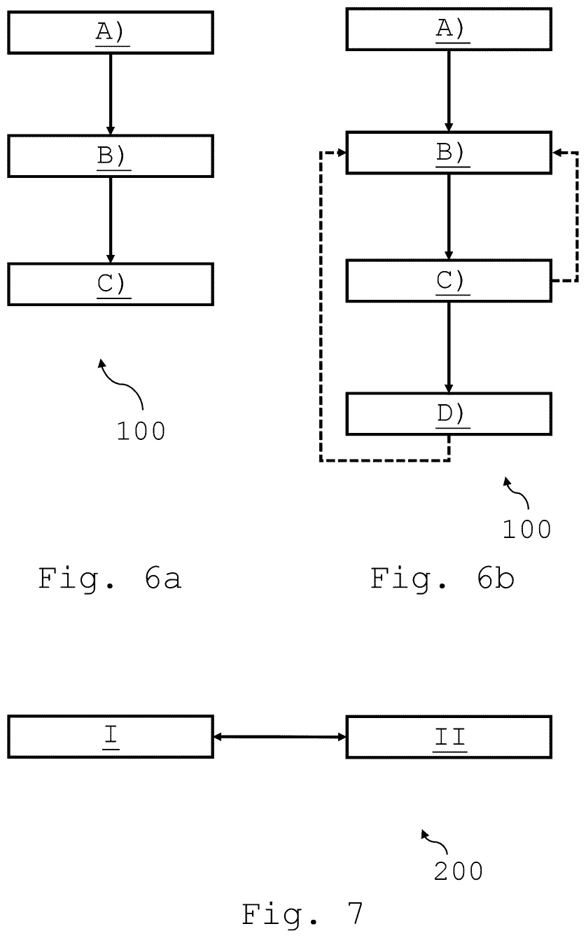

The optical sensor elements 15, 17 are coupled to respective communication components 18, 19. In the present exemplary embodiment, the communication components 18, 19 are designed as RFID transponders, each having a data processing device 20, 21 and in each case an antenna 22, 23. The respective data processing devices 20, 21 each contain storage devices 42, 43. In a development a controller 44 is configured to carry out the method according to the invention 100 (see FIG. 6a).

The mobile router 11 is arranged on the back of the first adhesive means 12. The mobile router 11 can be attached to the first adhesive means 12 via any connection mechanism, for example using an adhesive means. Optionally, the mobile router 11 can be configured as a reader for reading the data from the sensor arrangement 16. It is also conceivable for the mobile router 11 to be operated independently of the communication components 18, 19.

Within the scope of the embodiment variant shown, under the condition that there is adequate illumination of the surroundings by natural and/or artificial light, an adhesion state of the first adhesive means 12 to the second adhesive means 14 can be deduced by comparing the sensor data of the optical sensor elements 15, 17. In a further embodiment, the sensor elements 15, 17 can actively emit a light beam and record data on its reflection.

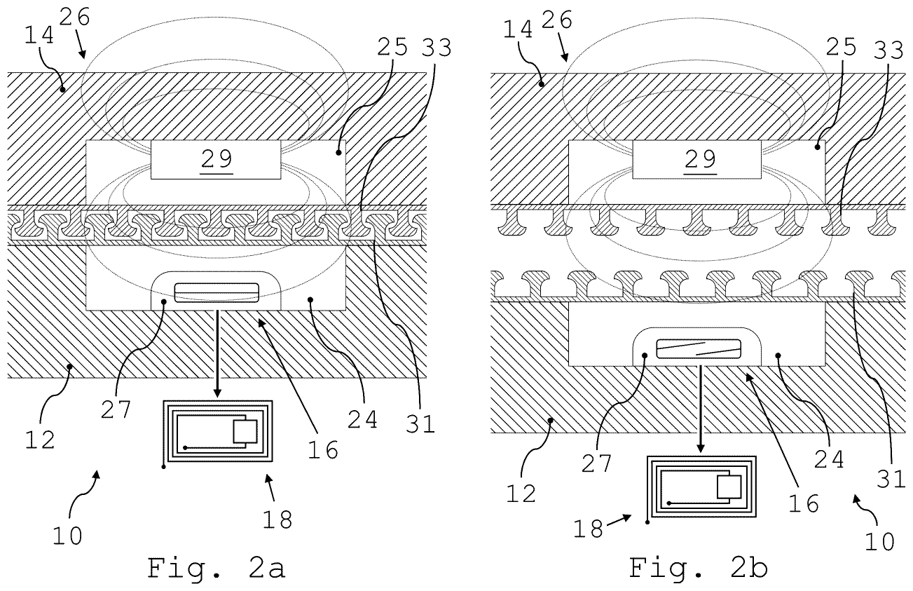

FIG. 2a and FIG. 2b show a further embodiment of a connection system 10, in each case in detail and in a partial section side view. A first adhesive means 12 has, in particular, a cavity 24 in which a sensor arrangement 16 is embedded. The sensor arrangement 16 is controlled by a magnetic sensor 27, in this case in the form of a reed switch. A second adhesive means 14 has a permanent magnet 29 (magnetic field lines indicated) embedded, in particular, in a cavity 25 of the second adhesive means 14, which magnet is suitable for triggering the magnetic sensor 27 when approaching/connecting between the first and second adhesive means 12, 14. In the illustrated exemplary embodiment, an adhesive connection can be achieved by an adhesive fastener 26, for example via mushroom heads 31, 33 arranged on the first and second adhesive means 12, 14.

In FIG. 2a, the connection system 10 is shown in the connected state, the permanent magnet 29 exerting a relatively large influence on the magnetic sensor 27. As a result, contact tongues within the magnetic sensor 27 are connected to each other and the magnetic sensor 27 generates a corresponding signal.

In FIG. 2b, the connection system 10 is in the detached state, with the magnetic sensor 27 being outside the perceptible range of influence of the permanent magnet 29, wherein the contact tongues of the magnetic sensor 27 are separated from each other. The sensor data in the states shown in FIGS. 2a and 2b are in each case transmitted to a communication component 18. The communication component 18 is designed in analogy to the embodiment variant in FIG. 1 in the form of an RFID transponder. In contrast to the sensor arrangement 16, the communication component 18 in this exemplary embodiment is not an integral part of the adhesive means 12, 14.

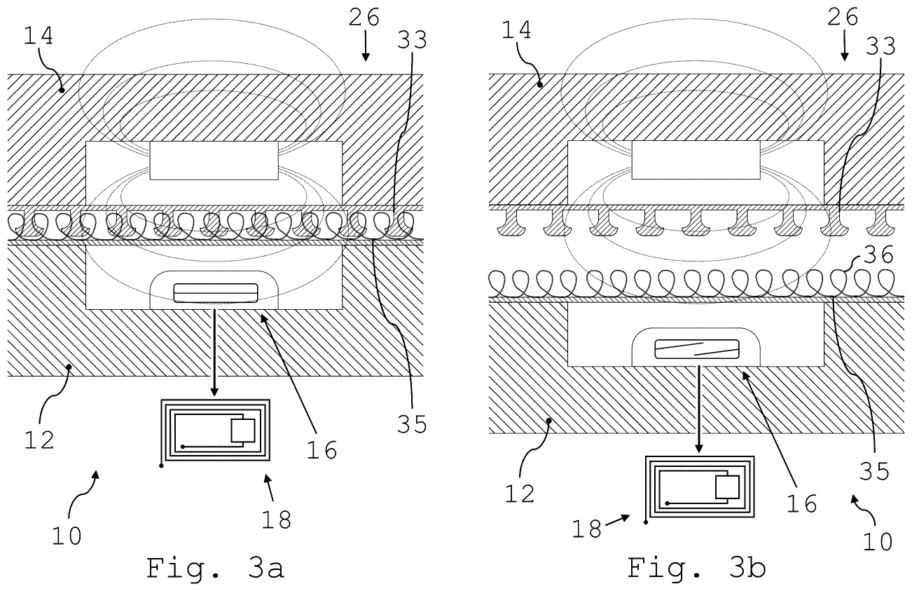

FIG. 3a and FIG. 3b show a further embodiment of a connection system 10, in each case in detail and in a partial section side view. The functioning of a sensor arrangement 16 and of a communication component 18 as well as the basic structure of the connection system 10 correspond to the embodiment variant from FIGS. 2a and 2b. In contrast to the previous variant, another form of an adhesive fastener 26 is shown here in the form of a hook and loop fastener. A first adhesive means 12 has loops 36 of a loop strip 35. A second adhesive means 14 has mushroom heads 33 which can hook into the loops 36 of the loop strip 35.

In FIG. 3a, the connection system 10 is again shown in the connected state, while FIG. 3b shows the detached state.

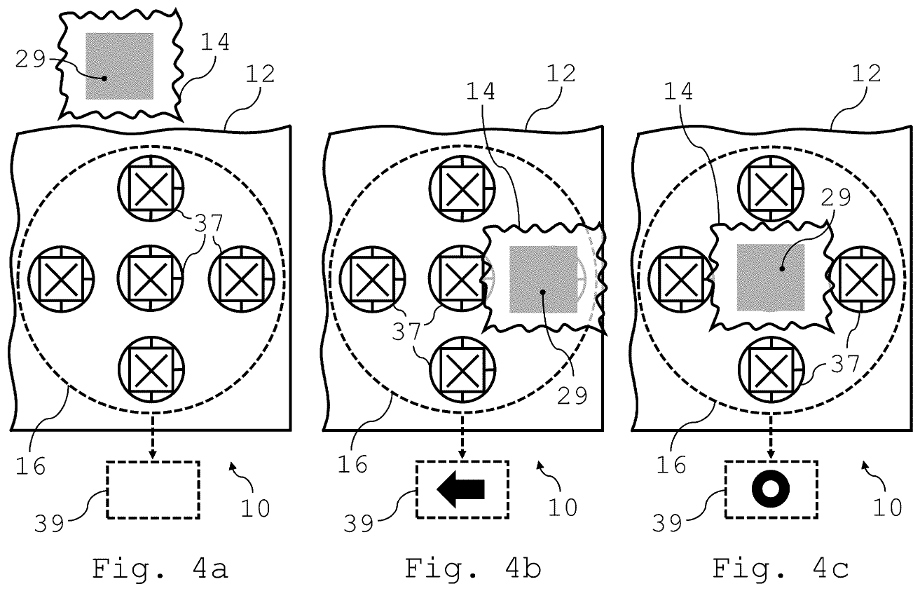

FIG. 4a, FIG. 4b and FIG. 4c each show detailed views of a further embodiment variant of a connection system 10. A sensor arrangement 16 has a plurality of magnetic sensors 37, which are designed here as Hall sensors. It is also conceivable to design the magnetic sensors 27 as reed switches (see FIGS. 2a-3b). The sensor arrangement 16 is integrated into a first adhesive means 12. A second adhesive means 14 has a permanent magnet 29. One or more communication components 18, 19 (see FIG. 1) are used to transmit the unprocessed or processed sensor data on the basis of which a display is output on a display means 39 regarding the positioning of the first adhesive means 12 in relation to the second adhesive means 14. It is understood that the connection system 10 in the present exemplary embodiment is designed such that bringing the adhesive means 12, 14 close together is already sufficient to output the display, the establishment of an actual adhesive connection for this purpose being optional. It is further understood that the display shown does not necessarily require an optical display means 39, but can be implemented equivalently by, for example, an acoustic and/or haptic display means 39. It is also conceivable for the display means 39 to be arranged or formed on the connection system 10, wireless transmission of the data not being necessary and the communication component(s) 18, 19 (see FIG. 1) not being used or not being present at all.

In FIG. 4a, the connection system 10 is shown in the detached, non-proximal state. The data of the sensor arrangement 16 of the first adhesive means 12 are used to indicate the state, wherein the display of the state can also include the absence of a signal. The distinction between the non-proximal and the proximal state is made on the basis of the detectability of the permanent magnet 29 by at least one of the magnetic sensors 37.

FIG. 4b shows a state in which the adhesive means 12, 14 are brought closer to each other or connected to each other, the relative position of the adhesive means 12, 14 not corresponding to an intended configuration. In this case, the generated display indicates both the misconfiguration and the corrective action to be taken.

FIG. 4c shows a state in which the first and second adhesive means 12, 14 are brought closer to each other or connected to each other, their relative position corresponding to an intended orientation. The display of the display device 39 signals the corresponding status.

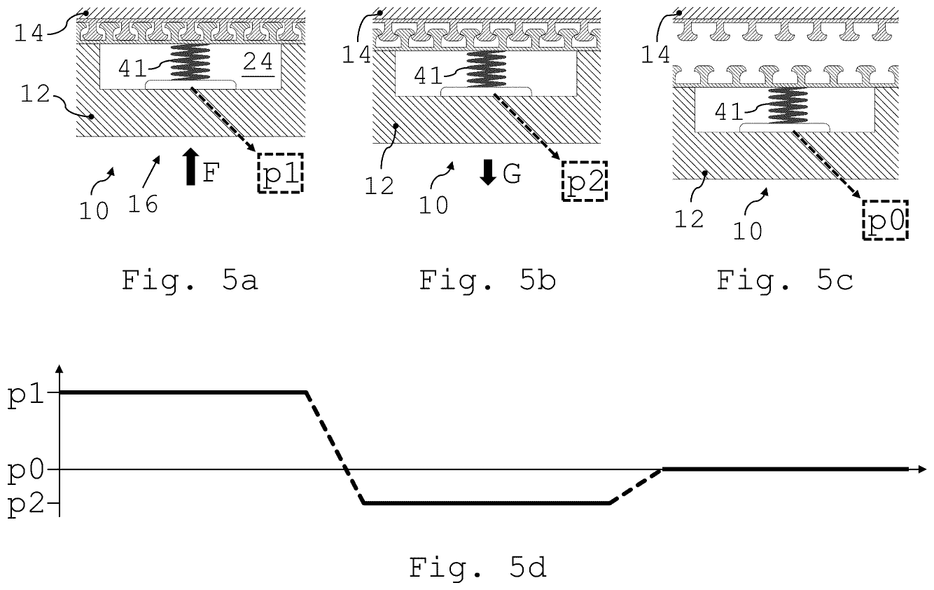

FIG. 5a, FIG. 5b and FIG. 5c show a further embodiment of a connection system 10, in each case in detail and in a partial section side view. A sensor arrangement 16 comprises a pressure sensor 41, in particular, a bidirectional differential pressure sensor 41. The pressure sensor 41 is shown schematically as a mechanical element in the present illustration. It is understood that other forms of pressure sensor 41, such as a piezoresistive element, may also be used. The sensor arrangement 16 is, in particular, embedded in a cavity 24 of a first adhesive means 12. The further components of the connection system 10 correspond to the embodiment variants shown in FIGS. 2a and 2b.

In FIG. 5a, the connection system 10 is shown in the connected state, the first adhesive means 12 being held by a force F in the direction of a second adhesive means 14 (i.e., in the connection direction). The second adhesive means 14 is stationary. The force F can, for example, be applied manually during the initial connection of the adhesive means 12, 14. The pressure sensor 41 of the sensor arrangement 16 detects the effect of the force F on the contact surface of the adhesive means 12, 14 in the form of pressure p1.

In FIG. 5b a force G acts on the system. The second adhesive means 14 is again stationary. The force G can, for example, be the force of gravity acting on the first adhesive means 12. The force G loads the connection between the first and second adhesive means 12, 14 against the connection direction, the pressure sensor 41 detecting the value p2.

In FIG. 5c, the connection between the first adhesive means 12 and the second adhesive means 14 is, or has become, detached. In this case, the pressure sensor 41 registers the value p0. This proves that the adhesive connection was released intentionally or unintentionally. Using the sensor values, the connection and load state (or the loading state and the non-loading state) of the connection system 10 can be reliably determined. This can be advantageous not only during the intended use of the connection system 10 but also during the checking and development of the connection system 10. Preferably, the connection system 10 has a plurality of pressure sensors 41 (not shown).

In FIG. 5d is shown a visualization of the values p1, p0 and p2 from FIGS. 5a-5c.

FIG. 6a shows a flowchart of a variant of the method 100 according to the invention in a preferred development. In step A) a first adhesive means 12 (see FIG. 1) is attached to a second adhesive means 14 (see FIG. 1). In step B) a parameter is detected by a sensor arrangement 16 (see FIG. 1). In step C) processed or unprocessed sensor data are sent by means of a communication component 18 (see FIG. 1).

FIG. 6b shows a flowchart of a further variant of the method 100 according to the invention in a further development. In step A), a first adhesive means 12 (see FIG. 1) is brought close to a second adhesive means 14 (see FIG. 1). In step B), a parameter relating to the positioning is detected by a sensor arrangement 16 (see FIG. 1). In particular, the position of the adhesive means 12, 14 (see FIG. 1) relative to each other in a plane parallel to their planar extents is detected (corresponds to the plane of representation in FIGS. 1, 4a-4c). In step C), processed or unprocessed sensor data are sent by means of a communication component 18 (see FIG. 1). Depending on the content of the sensor data, sub-steps B) and C) can be run through several times in succession. In step D) the first adhesive means 12 (see FIG. 1) is attached to the second adhesive means 14 (see FIG. 1). Optionally, step D) can be followed by step B) with the detection of a further parameter.

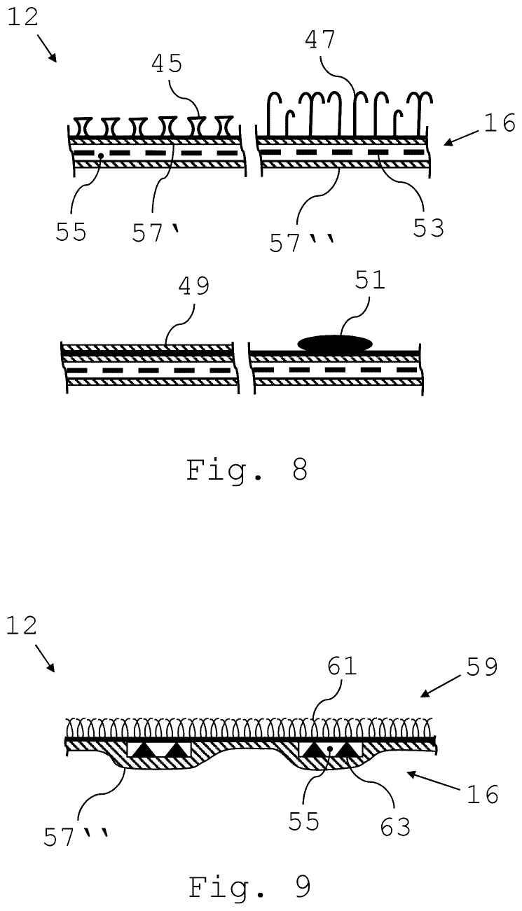

FIG. 7 shows a flowchart of a manufacturing method 200 for a connection system 10 (see FIG. 1). In step I the integration of a sensor arrangement 16 (see FIG. 1) takes place, for example, into a first adhesive means 12 (see FIG. 1). In step Il the integration of a communication component 18 (see FIG. 1) takes place, for example, into the first adhesive means 12 (see FIG. 1). Alternatively, step Il can be executed first and then step I, or step I and step II can be executed simultaneously. Further alternatively, only one of the steps can be performed.

FIG. 8 shows four variants of a first adhesive means 12 of a connection system 10 (see FIG. 1) with a sensor arrangement 16. The four variants differ only in the adhesive elements used to create the adhesive fastener 26 (see FIG. 2a). Shown are palm-shaped adhesive elements 45, hooks 47, an adhesive layer 49 and half of a snap fastener 51.

The four variants were advantageously produced in step I of the manufacturing method 200 (see FIG. 7). In this case, the sensor arrangement 16 comprises strain sensors 53, which are arranged in a carrier film 55. The carrier film 55 with the strain sensors 53 is connected via an adhesive layer 57′ arranged on the first adhesive means 12. Another layer of adhesive 57″ ensures embedding of the carrier film 55. It should be clarified again here that the adhesive layer 49 is not used to embed the carrier film 55 but to produce the adhesive connection of the connection system 10 (see FIG. 1). The adhesive layer 49 can be provided with a release liner during production (not shown).

FIG. 9 shows a further variant of a first adhesive means 12 with a sensor arrangement 16. The first adhesive means comprises a nonwoven 59 with corresponding fibers 61. The sensor arrangement 16 comprises force sensors 63, which are arranged in a carrier film 55. The carrier film 55 with the force sensors 63 is arranged in sections on the back of the first adhesive means 12 and embedded by means of an adhesive layer 57″. The variant shown, like the variants in FIG. 8, can be manufactured in a continuous production process.

Taking an overview of all figures in the drawing, in summary the invention relates to a method 100 for determining the condition of a connection system 10, comprising a first adhesive means 12, a second adhesive means 14 and a sensor arrangement 16. The method 100 can be used, in particular, to determine a position of the adhesive means 12, 14 relative to each other, the first adhesive means 12 being brought close to and/or attached to the second adhesive means 14 and at least one parameter relating to the positioning being detected by the sensor arrangement 16. After alignment of the adhesive means 12, 14, final attachment (or reattachment if necessary) can be carried out. The method 100 can equally be used, in particular, to detect the adhesion of the first adhesive means 12 to the second adhesive means 14 and/or to determine the loading or non-loading of an adhesive connection. In a preferred development of the method 100, processed and/or unprocessed sensor data can be sent wirelessly by means of a communication component 18. The invention further relates to a connection system 10 which is configured to carry out the aforementioned method 100 (possibly including the further developments of this method 100) and to a set 1 comprising the connection system 10 and a functional element, in particular, a mobile router 11. The invention further relates to a method 200 for producing the aforementioned connection system 10.

### LIST OF REFERENCE SIGNS

1 Set
10 Connection system
11 Mobile router
12 First adhesive means
13 Micro-structured surface
14 Second adhesive means
15 First optical sensor element
16 Sensor arrangement
17 Second optical sensor element
18 Communication component
19 Communication component
20 Data processing device
21 Data processing device
22 Antenna
23 Antenna
24 Cavity
25 Cavity
26 Adhesive fastener
27 Magnetic sensor (reed switch)
29 Permanent magnet
31 Mushroom heads
33 Mushroom heads
35 Loop strip
36 Loop
37 Magnetic sensor (Hall sensor)
39 Display means
41 Pressure sensor
42 Storage device
43 Storage device
44 Controller
45 Palm-shaped adhesive element
47 Hooks
49 Adhesive layer
51 Half of a snap fastener
53 Strain sensor
55 Carrier film
57′ Adhesive layer
57″ Adhesive layer
59 Nonwoven fabric
61 Fiber
63 Force sensor
100 Method for state detection of a connection system
200 Method for producing a connection system

What is claimed is:

1. A method for the state detection of a connection system, the method comprising the steps of:
providing the connection system comprising a first adhesive means and a second adhesive means, between which an adhesive connection is established, and wherein the connection system comprises a sensor arrangement;
A) approaching and/or attaching the first adhesive means to the second adhesive means;
B) detecting at least one parameter by the sensor arrangement relating to a state of the adhesive connection; and
D) attaching the first adhesive means to the second adhesive means, if this has not already been done in step A).

2. The method according to claim 1, wherein the sensor arrangement comprises a sensor element for detecting a displacement, a strain, a force, a pressure, a radiation energy, a molar concentration, or a magnetic field strength between the first adhesive means and the second adhesive means.

3. The method according to claim 1, wherein the sensor arrangement comprises at least one of the following sensor elements;
a) an optical sensor element;
b) a magnetic sensor;
c) a pressure sensor;
d) a force sensor;
e) a strain sensor;
with which sensor element the at least one parameter is detected; and/or
wherein the at least one parameter relates to
i. the positioning of the first adhesive means;
ii. the adhesion of the first adhesive means; and/or
iii. the loading of the adhesive connection, including its non-loading.

4. The method according to claim 1, wherein the sensor arrangement has two or more, identical or different sensor elements, with which sensor elements the at least one parameter is detected.

5. The method according to claim 1, wherein the data of the sensor arrangement are stored completely or partially in a storage device of the connection system at least temporarily.

6. The method according to claim 1, wherein the connection system has a data processing device in which the data of the sensor arrangement are processed.

7. The method according to claim 1, wherein the connection system comprises a communication component, wherein the method additionally comprises a step C) as follows:
C) wireless transmission of processed or unprocessed data of the sensor arrangement by means of the communication component.

8. The connection system comprising the first adhesive means, the second adhesive means, the sensor arrangement and the controller, wherein the connection system is configured to carry out the method according to claim 1.

9. The connection system according to claim 8, wherein the connection system comprises a storage device, wherein the data of the sensor arrangement are stored completely or partially in a storage device of the connection system at least temporarily, and/or, the connection system comprises a data processing device, wherein the connection system has a data processing device in which the data of the sensor arrangement are processed.

10. The connection system according to claim 8, wherein the sensor arrangement is arranged or formed on or in the first adhesive means and/or on or in the second adhesive means.

11. The connection system according to claim 8, wherein
a) the first adhesive means and/or the second adhesive means is/are part of an adhesive fastener, wherein the adhesive fastener comprises hooks, mushroom heads, palm-shaped adhesive elements, fibers and/or loops of a loop strip or a velour band or a woven fabric or a nonwoven fabric, and/or halves of a snap fastener;
b) the first adhesive means or the second adhesive means has/have micro-structures for utilizing intermolecular forces for the purpose of adhesion to smooth surfaces; and/or
c) the first adhesive means and/or the second adhesive means has/have an adhesive layer.

12. The connection system according to claim 8, wherein the connection system comprises a communication component, wherein the method additionally comprises a step C) as follows:
C) wireless transmission of processed or unprocessed data of the sensor arrangement by means of the at least one communication component.

13. The connection system according to claim 12, wherein the at least one communication component is arranged or formed on or in the first adhesive means and/or on or in the second adhesive means.

14. The connection system according to claim 12, wherein the at least one communication component is a passive element which does not have its own power supply, wherein the wireless transmission of the data of the sensor arrangement is configured to be triggered by means of a reader device.

15. A set comprising the connection system according to claim 8 and a functional element, being a mobile router, wherein the functional element is arranged on the first or the second adhesive means of the connection system.

16. A method for producing the connection system according to claim 8, comprising the following steps:
I) integration of a sensor arrangement into the first adhesive means and/or into the second adhesive means, or on the first adhesive means and/or on the second adhesive means, by weaving, or embedding, embedding in a cavity, or surface bonding; and/or
II) integration of a communication component into the first adhesive means and/or into the second adhesive means, or on the first adhesive means and/or on the second adhesive means, by weaving, or embedding, embedding in a cavity, or surface bonding, or printing, or vapor deposition, wherein the connection system comprises a communication component, wherein the method additionally comprises a step C) as follows:
C) wireless transmission of processed or unprocessed data of the sensor arrangement by means of the at least one communication component.
